(19) United States
(12) Patent Application Publication
(10) Pub. No.: US 2026/0348549 A1
(43) Pub. Date: Nov. 5, 2026

(54) LIGHTING DEVICE FOR A MOTOR VEHICLE

(71) Applicant: VALEO VISION, Bobigny (FR)

(72) Inventors: Blaise JARS, Bobigny (FR); Jade BERLIOZ-LATOUR, Bobigny (FR)

(73) Assignee: VALEO VISION, Bobigny (FR)

(21) Appl. No.: 19/152,637

(22) PCT Filed: Feb. 12, 2024
(86) PCT No.: PCT/EP2024/053429

§ 371 Date: Jul. 31, 2025

(30) Foreign Application Priority Data
Feb. 14, 2023 (FR) FR2301341

(51) Int. Cl. F21S 43/245; F21S 43/14; F21S 43/239; F21S 43/249; F21V 8/00

(52) U.S. Cl. CPC F21S 43/245; F21S 43/14; F21S 43/239; F21S 43/249; G02B 6/0036

(57) ABSTRACT

The invention relates to a lighting device. The lighting device includes a housing and a cover lens defining a cavity accommodating, on the one hand, at least two lighting modules, a first lighting module producing a first light beam and a second lighting module producing a second light beam, and, on the other hand, a signaling device including a light source and a light curtain arranged between the lighting modules and the cover lens, the light curtain includes micro-optical elements which are configured to decouple rays emitted by the light source and direct them into a signaling beam outside the light curtain in the direction of the cover lens, the micro-optical elements includes micro-optical elements of a first type which are arranged opposite the first lighting module and micro-optical elements of a second type which are arranged opposite the second lighting module.

### TECHNICAL FIELD

The present invention relates to the field of luminous devices, notably of automotive vehicles, and more particularly to luminous devices comprising at least one signaling device and one lighting device, which are intended to participate in the signaling and lighting functions of a vehicle.

### BACKGROUND OF THE INVENTION

Automotive vehicles traveling on the road are equipped with luminous devices, or headlamps, arranged on the front face of the vehicle. These lighting devices incorporate lighting functions, which are intended to improve the visibility of the road scene for the driver of the vehicle, and signaling functions, which are intended to make the driving actions of the driver and/or the vehicle visible to other road users, for example when the lighting functions are not being used notably during the day. These lighting and signaling functions must comply with regulatory standards.

The signaling functions may consist of a daytime running light function, a position light function, or a vehicle turn signal function, but this list is not exhaustive.

The lighting functions that can be implemented within the lighting devices may for example be a low-beam function or a high-beam function.

Low beams allow an automotive vehicle to be seen by other road users and allow its driver to see the roadway properly to a distance of 30 meters, without dazzling other users in the road scene. High beams emit light beams with a greater range so that the driver of the automotive vehicle can see the roadway properly to a distance of at least 100 meters, under nighttime conditions.

The high beams may be independent of the low beams, being generated by projection of a light beam formed on the basis of light rays emitted by light sources specifically dedicated to the formation of these high beams, or they may be generated by projection of a light beam complementary to that for forming the low beams, this complementary light beam being formed on the basis of light rays emitted by light sources arranged in a complementary manner to the light sources specifically dedicated to the formation of the low beams.

It is known, in a headlamp, to arrange different luminous modules in the center of the headlamp to provide the lighting functions, and one or more signaling functions are provided by signaling devices arranged at the periphery of the luminous modules. Thus, the lighting functions illuminate a central part of a lighting surface at the output of the headlamp while the signaling functions illuminate the periphery of this lighting surface.

Notably for esthetic and space reasons, car manufacturers wish to offer automotive vehicles equipped with headlamps in which the lighting and signaling functions are grouped together. The headlamps include a housing and a closing outer lens forming a receiving zone both for one or more luminous modules capable of generating the regulatory lighting functions via a portion of the closing outer lens, and for one or more signaling devices capable of generating a signaling function via the same portion of the closing outer lens or via a portion of the closing outer lens which is substantially the same. It should be noted that the lighting and signaling functions may illuminate the same surface of the closing outer lens or illuminate different surfaces, it being understood that it is desirable for the surfaces of the closing outer lens illuminated by either of these functions to overlap as much as possible.

It will be understood that a configuration as mentioned in the prior art cannot be used to form a compact luminous device having a light signature such that the surface of the closing outer lens illuminated by the signaling function shares at least one part with the surface of the closing outer lens illuminated by the lighting function.

### SUMMARY OF THE INVENTION

The present invention relates to the foregoing by proposing a luminous device for an automotive vehicle including a housing closed by a closing outer lens, said housing being configured to house on one side a lighting device including at least two lighting modules of which a first lighting module is capable of generating a first lighting beam and a second lighting module is capable of generating a second lighting beam, the first lighting beam being different from the second lighting beam and the two lighting beams being directed toward the closing outer lens so as to contribute respectively to a first lighting function with an upper cutoff and a second lighting function with no upper cutoff via a first portion of said closing outer lens, and on the other side a signaling device including at least one light source. According to the invention, the signaling device further includes a light curtain, arranged facing the at least one light source so that the rays emitted by the at least one light source can propagate therein, and arranged between the lighting modules and the closing outer lens, said light curtain including micro-optics configured to decouple the rays emitted by the at least one light source and direct them into a signaling beam outside the light curtain, toward the closing outer lens so as to generate a signaling function via a second portion of the closing outer lens at least partially overlapping the first portion of the closing outer lens, the micro-optics comprising two different types of micro-optics with micro-optics of a first type which are arranged in a first zone facing the first lighting module so as to be in the path of the first lighting beam and with micro-optics of a second type which are arranged in a second zone facing the second lighting module so as to be in the path of the second lighting beam.

The luminous device according to the invention comprises at least two lighting modules configured respectively to provide a lighting function for the road scene in front of the vehicle. In other words, the luminous device comprises at least one first lighting module configured to provide a first lighting function and at least one second lighting module configured to provide a second lighting function.

The luminous device according to the invention also comprises a signaling device, a transparent part of which, formed by a light curtain, is arranged between the closing outer lens and the lighting modules, i.e. in front of the lighting modules. The first and second light beams therefore pass through the light curtain before reaching the closing outer lens. The signaling device is configured so that the light curtain acts as a light guide equipped with optical patterns, more particularly micro-optics, which extract the light propagating within the light guide to direct it toward the outside of the vehicle and provide the desired signaling function.

At least one lighting module and the signaling device are configured so that the corresponding lighting function and the signaling function are both emitted along an optical axis parallel to a median longitudinal axis of the vehicle and substantially parallel to the surface of the road on which the vehicle is driving.

Each optical or micro-optical pattern formed on the light curtain of the signaling device has an effect on at least one of the light rays emitted by the at least one light source of the signaling device and propagating within the light curtain, so that each optical pattern participates in the provision of the signaling function.

These same patterns have distinct shapes, so that some of these optical patterns, arranged facing a first lighting module involved in the provision of a first lighting function, has patterns of a first type so as not to interfere with the provision of this first specific lighting function, and so that some of these optical patterns, arranged facing a second lighting module involved in the provision of a second lighting function, presents patterns of a second type so as not to interfere with the provision of this second specific lighting function.

According to an optional feature of the invention, the upper cutoff of the lighting function provided at least in part by the first lighting module includes at least one horizontal and/or oblique portion.

According to an optional feature of the invention, the light curtain is formed by a sheet-shaped light guide.

According to an optional feature of the invention, the first lighting module contributes to the provision of a low-beam function and the second lighting module contributes to the provision of a high-beam function.

According to an optional feature of the invention, the signaling device is configured to generate a direction-indicator-light, daytime-running-light or position-light signaling function.

According to an optional feature of the invention, the micro-optics are formed on a first face of the light curtain, facing the lighting modules.

According to an optional feature of the invention, the first-type micro-optics are configured to generate a diffusing effect on the rays generated by the first lighting module and on the rays propagating within the light curtain.

The first-type micro-optics are configured to be diffusing. This diffusing effect nevertheless allows rays emitted by the light source of the signaling device to be extracted from the light curtain and propagated in the signaling device. It also ensures that road users are not dazzled when the vehicle equipped with the luminous device according to the invention emits the first lighting function provided with an upper cutoff, such as a low-beam lighting function.

Indeed, when the first light beam corresponding to the first lighting function passes through the light curtain and the first-type micro-optics, these also have a diffusing effect on the first light beam, which prevents directional light from being sent above the upper cutoff of the first lighting function.

According to an optional feature of the invention, the first-type micro-optics have the shape of a cone extending about an axis of revolution, respectively.

According to an optional feature of the invention, the axis of revolution of at least one cone has an angle of inclination of between 25° and 70° with respect to the main plane of elongation of the first face of the light curtain. This angle of inclination may notably be 45°.

According to an optional feature of the invention, the second-type micro-optics are configured to generate a directional effect on the rays generated by the second lighting module.

Each second-type micro-optic can notably take the form of a prism. The planar faces of the prism allowing this directional effect are joined by a transversely extending edge, so as to give a vertical directional effect to the rays reaching the prism with an essentially longitudinal direction.

This directional effect allows rays emitted by the light source of the signaling device to be extracted from the light curtain and propagated in the signaling device. It should be noted that micro-optics with a directional effect are more efficient than micro-optics with a diffusing effect at extracting the rays emitted by the light source of the signaling device. In addition, when the vehicle fitted with the luminous device according to the invention emits the second lighting function with no upper cutoff, such as a high-beam lighting function, even though the second-type micro-optics with a directional effect impact the second lighting beam, it remains compliant with applicable regulations, and since the lighting function has no upper cutoff, there is no risk of dazzling other road users.

According to an optional feature of the invention, the second-type micro-optics comprise hybrid micro-optics, each of which has the general shape of a prism, capable of generating said directional effect on the rays generated by the second lighting module, with cone portions arranged laterally to the prism.

These hybrid micro-optics form a particular embodiment of second-type micro-optics and are placed accordingly in the second zone facing the second lighting module involved in generating the lighting function with no cutoff, and where consequently the general prism shape cannot pose a risk of dazzling road users. Moreover, the presence of the cone portions at the lateral ends of the prism is used to keep the signaling function uniform since they have the effect of diffusing the light rays propagating within the light curtain, consistent with the diffusing effect provided by first-type micro-optics, which are all conical, positioned in front of the first lighting module providing the first lighting function with an upper cutoff, such as a low-beam lighting function.

The configuration of micro-optics is significant. The types of micro-optics are an integral part of the signaling device and have to enable the signaling function to be provided without excessively disturbing the first and second lighting functions. They are therefore arranged in consideration of the nature of the lighting module.

Micro-optics generating a diffusing effect, such as micro-optics having a cone shape, are used to distribute the light in all directions. They thus make it possible to extract some of the rays emitted by the light source associated with the signaling device and, by being arranged facing the first lighting module forming a beam with an upper cutoff such as a low beam, and having a diffusing property, they send a negligible amount of light above the upper cutoff of the first lighting beam compared to the limit imposed by regulatory constraints. This upper cutoff is defined notably in the regulations. It is a limit beyond which little or no light may be sent, to ensure other road users are not dazzled. It is therefore desirable not to send light beyond this limit.

On the other hand, micro-optics that generate a directional effect, such as micro-optics with a prism shape, allow light to be sent in a single direction. They are therefore used to extract some of the rays emitted by the light source associated with the signaling device. The impact of these micro-optics on the second lighting function remains limited, notably because the second lighting function has no upper cutoff, such as a high-beam function. Indeed, in this case, the regulations do not define a zone beyond which little or no light may be sent. Micro-optics generating a directional effect therefore do not cause problems of dazzling. They can have an impact on the range and/or flux of the second lighting function, without affecting the regulatory compliance of the second lighting function.

Moreover, as explained above, by allowing more rays emitted by the light source of the signaling device to be extracted than micro-optics generating a diffusing effect, micro-optics generating a directional effect are used to achieve the photometry required to provide the signaling function.

Indeed, if only micro-optics generating a diffusing effect were used on the entire surface of the light curtain, the photometry regulations applicable to the signaling device would not be met. In other words, it would not be possible to send enough light to the desired locations to provide the signaling function.

On the other hand, if only micro-optics generating a directional effect were used on the entire surface of the light curtain, the first lighting function formed by a first lighting beam with an upper cutoff would be too disturbed by the micro-optics and would then no longer meet regulations. The directional micro-optics would send too much light above the upper cutoff.

This distribution of the types of micro-optics allows the lighting device to provide a first lighting function with an upper cutoff, for example a low-beam function, and a second lighting function with no upper cutoff, for example a high-beam function, while allowing the signaling device to provide a signaling function, each according to their respective applicable regulations.

According to an optional feature of the invention, the signaling device comprises a plurality of light sources arranged facing an edge of the light curtain.

These light sources are notably arranged at regular intervals. Light intended to generate a signaling function is thus propagated uniformly over the entire transverse dimension of the light curtain.

According to one feature of the invention, the signaling device comprises collimators arranged between the light sources and the light curtain. The collimators may notably form an integral part of the light curtain so as to form a single plastic piece and be arranged on one face of the light curtain facing the light sources. The collimators are used to collect the light beams emitted by the light sources and transmit them within the light curtain in a beam of parallel or substantially parallel rays.

According to one feature of the invention, each lighting module of the lighting device comprises a light source and a reflector, the reflectors being arranged to reflect the beams emitted by the light sources toward the closing outer lens of the luminous device.

According to one feature of the invention, two first lighting modules are arranged on either side of a second lighting module and the first-type micro-optics are arranged in two distinct first zones, arranged on either side of a second zone in which the second-type micro-optics are arranged.

### BRIEF DESCRIPTION OF THE DRAWINGS

Other features, details and advantages of the invention will become clearer on reading the description of a detailed embodiment given by way of non-limiting example with reference to the attached schematic drawings, in which:

FIG. 1 is a schematic sectional view of a luminous device according to the invention, this sectional view notably showing the arrangement of a light curtain of a signaling device between means forming a lighting module and a closing outer lens of a housing of the luminous device;

FIG. 2 is a schematic view of a detail of FIG. 1, showing micro-optics on one face of the light curtain facing the lighting modules;

FIG. 3 is a front view of a part of a luminous device according to the representation in FIG. 1, notably showing two lighting modules capable of contributing respectively to the provision of a low-beam function and a high-beam function, these modules being shown here through the transparent light curtain forming part of the signaling device arranged according to the invention facing the lighting modules;

FIG. 4 is a schematic view of the light curtain of the signaling device, with a zone of first-type micro-optics and a zone of second-type micro-optics;

FIG. 5 is a schematic view of a plurality of cone-shaped first-type micro-optics;

FIG. 6 is a schematic view of a plurality of hybrid micro-optics; and

FIG. 7 is a schematic view of a variant embodiment of the light curtain of the luminous device, with two zones of first-type micro-optics arranged on either side of the zone of second-type micro-optics.

### DETAILED DESCRIPTION OF THE INVENTION

The features, variants and different embodiments of the invention can be associated with one another in various combinations, provided that they are not mutually incompatible or mutually exclusive. It will be possible, notably, to imagine variants of the invention that comprise only a selection of the features described below, in isolation from the other features described, if this selection of features is sufficient to confer a technical advantage and/or to distinguish the invention from the prior art.

As a reminder, the invention relates to a luminous device providing both lighting functions and a signaling function, via lighting and signaling beams projected through the same portion of the closing outer lens of this luminous device. This functionality is made possible in the luminous device according to the invention by the fact that a signaling device is arranged between the means implementing the lighting functions and the closing outer lens, and to the extent that appropriate optical patterns are formed on the signaling device to enable the signaling function to be generated without interfering with the lighting function.

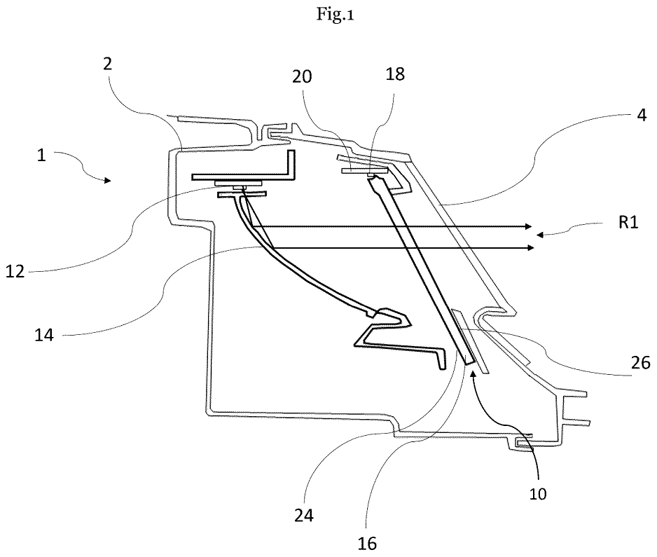

FIG. 1 is a schematic sectional view of a luminous device 1 according to the invention. The luminous device 1 is more particularly a headlamp intended to be integrated in a front face of an automotive vehicle. The luminous device 1 is capable of implementing several lighting and signaling functions of the vehicle, via luminous modules including lighting modules and a signaling device.

The luminous device 1 includes a housing 2 having an opening which is turned toward the front of the vehicle and closed by a closing outer lens 4. The housing 2 and the closing outer lens 4 define a receiving cavity dimensioned to house the various luminous modules mentioned above.

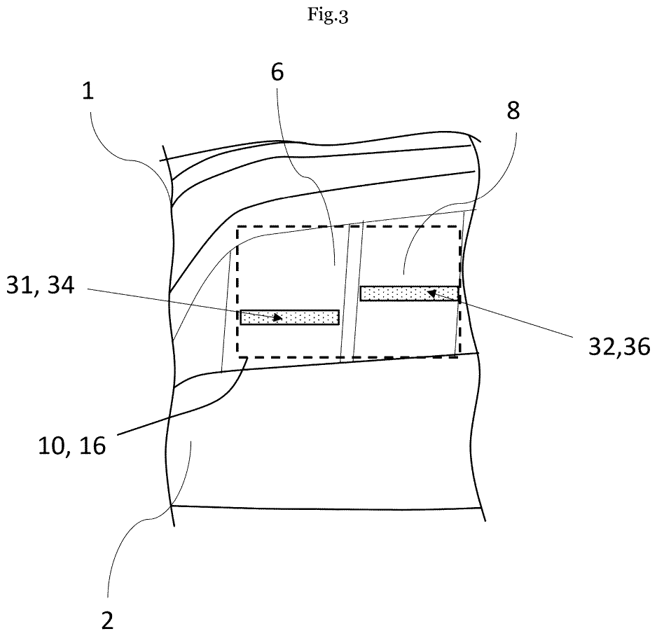

More particularly, the housing 2 houses at least two lighting modules providing two distinct lighting functions, including a first lighting module, or low-beam module 6, intended to provide a low-beam function and a second lighting module, or high-beam module 8, intended to provide a high-beam function. This housing 2 also houses a signaling device 10, a transparent part of which is arranged between the lighting modules 6, 8 and the closing outer lens 4. It will be understood that in FIG. 3, which is a view from outside the vehicle, the lighting modules 6, 8 are seen through the transparent closing outer lens 4 and the transparent part of the signaling device.

Each lighting module 6, 8 includes a light source 12 and a means for guiding the light rays emitted by the light source, in order to direct these light rays toward the output of the housing, i.e. in this case toward the closing outer lens 4.

The light source 12 is configured to emit light rays at a defined luminous intensity, appropriate for the provision of the lighting function associated with its related lighting module. The figure thus shows a light source 12 arranged facing the low-beam module 6 and configured to emit rays enabling a first, low-beam lighting beam to be produced, and a light source 12 arranged facing the high-beam module 8 and configured to emit rays used to provide a second, high-beam lighting beam.

The means for guiding the light rays is in this case formed by a reflector 14, the shape and size of which are defined to generate a beam of parallel rays, or substantially parallel rays, toward the closing outer lens 4 in order to produce a high-beam or low-beam lighting beam. The reflector 14 is in this case a reflector with a parabolic portion, which is arranged so that the corresponding light source 12 is arranged at the focus of this parabolic shape. FIG. 1 illustrates by way of example two rays R1 propagating toward the closing outer lens 4. It should be understood that these rays could just as well be generated by the first lighting module 6 as by the second lighting module 8.

As mentioned, the signaling device 10 includes a transparent part arranged between the lighting modules, and more particularly the reflectors 14 of the lighting modules, and the closing outer lens 4. This transparent part consists of a light curtain 16 which is formed by a sheet-shaped light guide. The light curtain 16 is sheet-shaped in that its thickness is small compared with the other two dimensions defining its main plane of elongation. As a non-limiting example of the invention, the light curtain 16 has a thickness of about 5 mm.

It is notable that the rays R1 mentioned above, emitted by one or other of the lighting modules 6, 8, are caused to pass through the light curtain 16.

The signaling device 10 further includes one or more light sources 18 which are configured and dimensioned within the luminous device 1 to provide the signaling function. The light sources 18 in this case consist of light-emitting diodes fastened to a printed circuit board 20. The light sources 18 can be configured to emit a single color, or to emit different colors according to the control instructions appropriately received by a control system of the signaling device. For example, the light source may emit rays of white light if the signaling function to be implemented is a position-light or daytime-running-light function, and it may emit rays of orange light if the signaling function to be provided is a direction-indicator function.

The printed circuit board 20 is positioned in the housing 2 so that the light sources 18 are arranged as close as possible to an edge of a light curtain 16, so that all, or at least a large majority, of the emitted light rays propagate within the light guide formed by the light curtain.

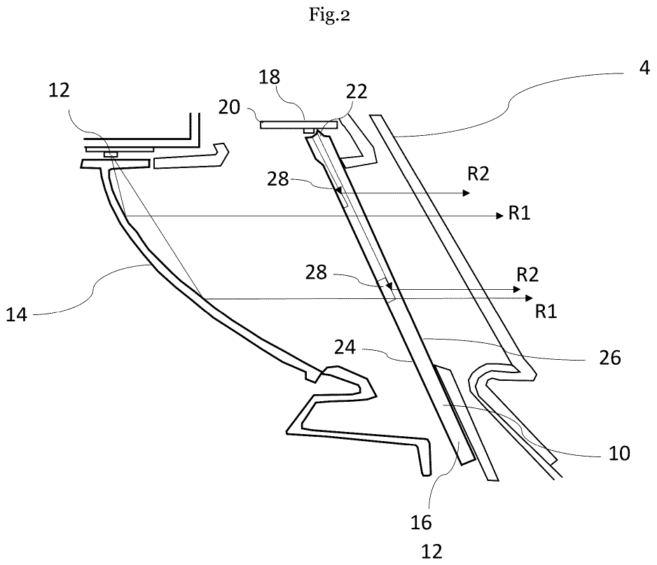

Collimators 22, visible in FIG. 2, are in this case arranged between the light sources 18 and the light curtain 16 so as to respectively collect the signaling beams emitted by each of the light sources 18 and transmit them within said light curtain 16 in a beam of parallel or substantially parallel rays. In this context, the light rays emitted by the collimated light sources 18 propagate within the light guide formed by the light curtain 16 from the edge facing the light sources to the opposite edge.

The light curtain 16 has two main faces opposing each other, including a first face 24 which faces the lighting modules 6, 8 and an opposite second face 26 which faces the closing outer lens 4. This second face 26 forms an output face for the light rays propagating within the light curtain.

In order to extract the light rays propagating within the light curtain, the first face 24 of the light curtain, as shown more particularly in FIG. 2, has at least one extraction zone 28 equipped with optical patterns which are used to decouple the light rays within the light curtain beams, i.e. deflecting the rays so that they impact the opposite face to the optical patterns, i.e. the output face, with an angle of incidence causing them to exit by refraction from the light curtain 16, toward the closing outer lens 4, in order to generate the signaling function.

The optical patterns consist of reliefs formed on the first face, which may have various shapes as described below. Notably in this case, the reliefs form an indentation of appropriate shape in the material, so as to be arranged across the path, within the light curtain, of the light rays emitted by the light sources.

As mentioned above, it is notable that the rays R1 mentioned above, emitted by one or other of the lighting modules 6, 8, are caused to pass through the light curtain 16. More particularly, as shown in FIG. 2, some of the rays R1 emitted by one or other of the lighting modules 6, 8 are caused to pass through the extraction zone 28 and its optical patterns.

FIG. 2 shows two distinct extraction zones, arranged successively on the first face 24 of the light curtain 16, these extraction zones being thus distributed differently in front of the reflectors 14 of the lighting modules. It is notable that the portion of the first face 24 facing the first lighting module may have one or more extraction zones at positions different from the positions on another portion of the first face 24, in this case facing the second lighting module.

Moreover, it should be noted that the dimension of the extraction zones and notably the depth at which they engage in the material of the light curtain is exaggerated here to make them visible in the figure. Regardless of the thickness of the light curtain, the micro-optics may have a depth of between 0.05 mm and 0.6 mm, the minimum dimension being determined by production constraints, while the maximum dimension is determined by esthetic constraints related to injection. The micro-optics may notably have a depth of the order of 0.15 mm.

More particularly, in the example illustrated, the light curtain includes two extraction zones with a first extraction zone closer to the light source than the second extraction zone, and the first extraction zone has a depth of the order of 0.1 mm while the second extraction zone has a depth of the order of 0.2 mm. This depth offset, with a progressive depth between the two extraction zones, if necessary, is advisable to maximize the efficiency of the second extraction zone.

The optical patterns forming an extraction zone are micro-optics 30 configured to have an impact on the light rays propagating within the light curtain 16 in order to deflect them out of the light curtain toward the closing outer lens 4, as shown by the lines representing the rays R2 without interfering with the propagation of the light rays coming from the lighting modules 6, 8 that are involved in generating a lighting function, shown by the lines representing the rays R1.

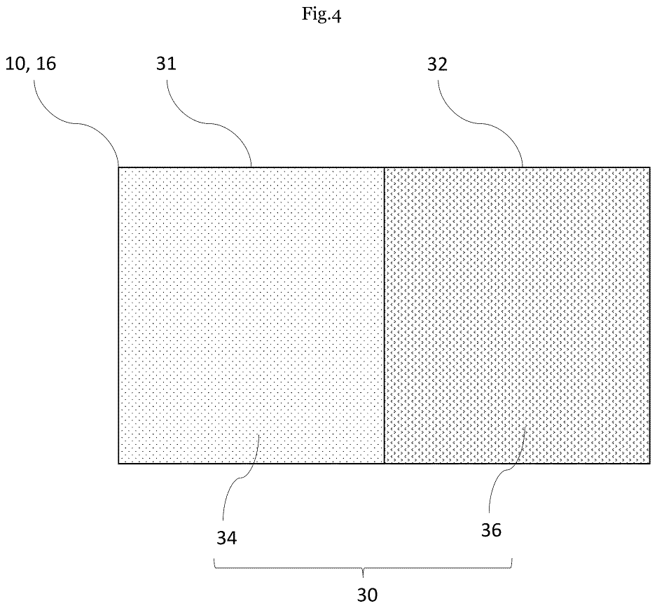

As mentioned above, and as illustrated in FIG. 3, there are two different types of lighting modules 6, 8, with at least one lighting module involved in generating a low-beam lighting function and one lighting module involved in generating a high-beam lighting function. In this context, according to the invention, the micro-optics 30 are divided into micro-optics of different types, depending on the lighting module they are directly facing. The arrangement of the micro-optics illustrated in FIG. 4 corresponds to the arrangement of the lighting modules illustrated in FIG. 3, with two lighting modules 6, 8 arranged side by side in a transverse direction, and two zones 31, 32 of distinct micro-optics 30 arranged side by side in this same transverse direction.

More particularly, it will be understood that the first zone 31 is composed of first-type micro-optics 34, and it is arranged facing the first lighting module 6, contributing to the provision of the low-beam function. The second zone 32 is composed of second-type micro-optics 36, this second zone 32 being arranged facing the second lighting module 8, contributing to the provision of the high-beam function.

It will be understood that each micro-optic participates in the provision of the signaling function by providing a relief within the light curtain which is intended to deflect at least one of the light rays emitted by the at least one light source of the signaling device out of the light curtain, and they have distinct shapes so that they can be positioned facing one of the lighting modules, with the minimum effect on the lighting beam emitted by the corresponding module.

The first-type micro-optics 34 may take different forms, provided that they are essentially diffusing to ensure they do not dazzle road users when the vehicle equipped with the luminous device according to the invention emits a low-beam lighting function. The first-type micro-optics 34 are thus configured to deflect the light rays coming from the lighting modules 6, 8 in very small proportions, generating at most a luminous intensity outside the initial trajectory of the light rays of the order of 1 Lux.

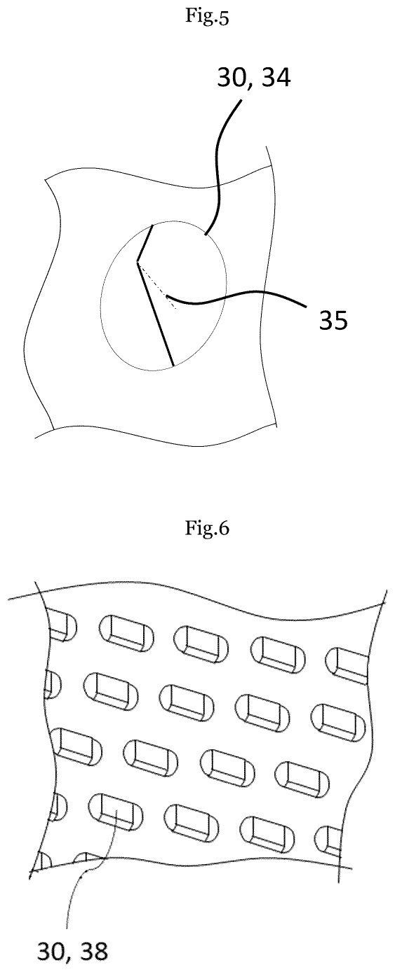

By way of example and as illustrated in FIG. 5, these first-type micro-optics 34 respectively take the form of a cone, centered around an axis of revolution 35 that is oriented with respect to the main plane of elongation of the light curtain and with respect to a longitudinal and transverse plane in which the light rays coming from the lighting modules 6, 8 mainly extend.

The orientation of the cones depends notably on the optical axis of the lighting modules and the signaling device. Each cone extends around an axis of revolution which is in this case parallel to the direction of the optical axis of the lighting modules. The axis of revolution is inclined with respect to this optical axis, in a vertical plane perpendicular to the plane of elongation of the light curtain.

It should be noted that the angle of inclination of the axis of revolution of each cone has little or no impact on the lighting function, the angular modification in the propagation of the rays being negligible in terms of dazzling. However, this angle of inclination of each cone is limited to a value between 25° and 70° so as not to affect the uniformity of the signaling function.

By way of non-limiting example of the invention, the cones each have a radius of the order of 0.15 mm, measured in the plane of the input face of the light curtain, and an axial depth, along the axis of revolution, also of the order of 0.15 mm.

In the first zone including these first-type micro-optics, the cones may be spaced apart from each other by 0.5 mm, this value being measured between two adjacent cones on the first face of the light curtain, between the center of one cone and the center of the other cone.

The second-type micro-optics 36 are essentially directional and can take the form of a prism, the planar faces of the prism ensuring the targeted deflection of the light rays emitted by one of the lighting modules. This deflection is essentially vertical, because of the longitudinal orientation of the light rays emitted by one of the lighting modules and the inclination of the face of the prism mainly traversed by these rays. It is thus advantageous for the second-type micro-optics 36 to be arranged in the second zone 32, facing the second lighting module 8, i.e. the lighting module involved in the provision of a high-beam lighting function. The beam enabling this function to be provided is long range and of high luminous intensity, so that it is only implemented when there are no road users in front of the vehicle and the vertical offset does not constitute a regulatory problem or interfere with the provision of the high-beam lighting function.

It will be understood that the presence of diffusing micro-optics in the second zone 32, as used in the first zone 31, would be detrimental to the proper provision of the signaling function. This signaling function could have insufficient luminous intensity to ensure regulatory compliance, on account of insufficient light being extracted by the light curtain.

Similarly, the presence of directional micro-optics in the first zone 31, as used in the second zone 32, would be detrimental to the satisfactory provision of the low-beam lighting function, since the cutoff to ensure other users are not dazzled would not be respected because of the vertical deflection of the rays.

FIG. 6 illustrates a variant in the embodiment of the micro-optics 30, which may have a hybrid configuration, mixing the cone configuration and the prism configuration. The hybrid micro-optics 38 are notably formed by a prism-shaped central portion and lateral portions in the form of cone portions. These hybrid micro-optics 38 are intended notably to replace the second-type micro-optics 36 in the second micro-optics zone 32, i.e. in the zone facing the second lighting module 8. Indeed, the central portion of the micro-optics is the portion mainly impacted by the light rays emanating from the lighting modules and its prism shape takes the shape of second-type micro-optics, so as not to interfere with the provision of the lighting function and notably to enable enough light to be extracted to provide the signaling function.

The sides of the micro-optics, in the form of cone portions, have an additional effect for decoupling the light rays propagating within the light curtain 16. The conical shape generates a reflection of the light rays toward the opposite face with an angle of incidence different from the light rays reflected by the central portion, and it thus ensures better distribution of the rays on the output face of the light curtain and better uniformity of the signaling function of the vehicle. Light rays of the signal beam thus exit the headlamp with an inclination with respect to the longitudinal direction perpendicular to the plane of elongation of the light curtain, which improves visibility of the signal beam for an outside observer viewing the vehicle from the side.

FIG. 6 illustrates a preferred embodiment for this variant, with cone portions which are arranged on either side of the prismatic central portion, in the transverse direction mentioned above.

It follows from the foregoing that the invention applies notably to a headlamp including two distinct lighting modules arranged side by side. However, this arrangement does not limit the invention, as long as a single light curtain is arranged between the lighting modules and the output of the headlamp, and this light curtain includes zones with different patterns between one zone and its adjacent zone, the patterns depending on the lighting modules they are facing.

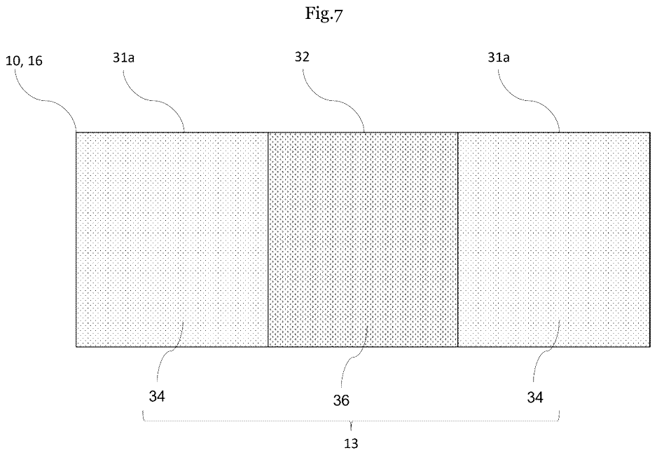

Thus, by way of non-limiting example, FIG. 7 illustrates a variant embodiment of the invention, illustrating more particularly the light curtain 10 specific to this variant, namely a light curtain including two first zones 31 composed of first-type micro-optics 14, arranged on either side of a second zone 32 composed of second-type micro-optics 36 and/or hybrid micro-optics 38. Of course, this light curtain configuration with two first zones arranged on either side of a second zone is associated with a specific configuration of the lighting modules, with two first lighting modules involved in the provision of a first, low-beam lighting beam arranged on either side of a second lighting module involved in the provision of a second, high-beam lighting beam.

The detailed description above clearly illustrates that the present invention achieves its stated aims, i.e. to propose a luminous device for generating a signaling function and two lighting functions uniformly on the same portion of the closing outer lens formed by an output surface of a headlamp, this being made possible by the presence of a light curtain facing the lighting modules so that the signaling function can be projected into the center of the portion of the closing outer lens and thus achieve a degree of uniformity which is not possible if this signaling function is generated at the periphery of this closing outer lens portion. The light curtain is also configured so as not to interfere with the provision of either of the two lighting functions via beams of light rays caused to pass through the light curtain.

However, the present invention is not limited to the means and configurations described and illustrated here and it also extends to any equivalent means and configurations and to any technically operational combination of such means.

What is claimed is:

1. A luminous for an automotive vehicle comprising housing closed by a closing outer lens, the housing being configured to house on one side a lighting device including at least two lighting modules of which a first lighting module is capable of generating a first lighting beam and a second lighting module is capable of generating a second lighting beam, the first lighting beam being different from the second lighting beam and the two lighting beams being directed toward the closing outer lens so as to contribute respectively to a first lighting function with an upper cutoff and a second lighting function with no upper cutoff via a first portion of the closing outer lens, and on the other side a signaling device including at least one light source, wherein the signaling device further includes a light curtain, arranged facing the at least one light source so that the rays emitted by the at least one light source can propagate therein, and arranged between the lighting modules and the closing outer lens, the light curtain including micro-optics configured to decouple the rays emitted by the at least one light source and direct them into a signaling beam outside the light curtain, toward the closing outer lens so as to generate a signaling function via a second portion of the closing outer lens at least partially overlapping the first portion of the closing outer lens, the micro-optics includes two different types of micro-optics with micro-optics of a first type which are arranged in a first zone facing the first lighting module so as to be in the path of the first lighting beam and with micro-optics of a second type which are arranged in a second zone facing the second lighting module so as to be in the path of the second lighting beam.

2. The luminous device for an automotive vehicle as claimed in claim 1, wherein the light curtain is formed by a sheet-shaped light guide.

3. The luminous device for an automotive vehicle as claimed in claim 1, wherein the first lighting module contributes to the provision of a low-beam function and in that the second lighting module contributes to the provision of a high-beam function.

4. The luminous device for an automotive vehicle as claimed in claim 1, wherein the signaling device is configured to generate a direction-indicator-light, daytime-running-light or position-light signaling function.

5. The luminous device for an automotive vehicle as claimed in claim 1, wherein the micro-optics are formed on a first face of the light curtain, facing the lighting modules.

6. The luminous device for an automotive vehicle as claimed in claim 1, wherein the first-type micro-optics are configured to generate a diffusing effect on the rays generated by the first lighting module and on the rays propagating within the light curtain.

7. The luminous device for an automotive vehicle as claimed in claim 6, wherein the first-type micro-optics have the shape of a cone extending about an axis of revolution.

8. The luminous device for an automotive vehicle as claimed in claim 1, wherein the second-type micro-optics are configured to generate a directional effect on the rays generated by the second lighting module.

9. The luminous device for an automotive vehicle as claimed in claim 8, wherein the second-type micro-optics includes hybrid micro-optics, each of which has the general shape of a prism, capable of generating the directional effect on the rays generated by the second lighting module, with cone portions arranged laterally to the prism.

10. The luminous device for an automotive vehicle as claimed in claim 1, wherein the signaling device includes a plurality of light sources arranged facing an edge of the light curtain.

11. The luminous device for an automotive vehicle as claimed in claim 1, wherein the signaling device includes collimators arranged between the light sources and the light curtain.

12. The luminous device for an automotive vehicle as claimed in claim 1, wherein each lighting module of the lighting device includes a light source and a reflector, the reflectors being arranged to reflect the beams emitted by the light sources toward the closing outer lens of the luminous device.

13. The luminous device for an automotive vehicle as claimed in claim 1, wherein two first lighting modules are arranged on either side of a second lighting module and in that the first-type micro-optics are arranged in two distinct first zones arranged on either side of a second zone in which the second-type micro-optics are arranged.
